(19) United States
(12) Patent Application Publication
(10) Pub. No.: US 2017/0141825 A1
(43) Pub. Date: May 18, 2017

(54) BEAM-BASED INFORMATION TRANSMISSION METHOD AND APPARATUS AND COMMUNICATIONS SYSTEM

(71) Applicant: FUJITSU LIMITED, Kawasaki-shi (JP)

(72) Inventors: YI ZHANG, Beijing (CN); HUA ZHOU, Beijing (CN)

(73) Assignee: FUJITSU LIMITED, Kawasaki-shi (JP)

(21) Appl. No.: 15/419,356

(22) Filed: Jan. 30, 2017

Related U.S. Application Data
(63) Continuation of application No. PCT/CN2014/083987, filed on Aug. 8, 2014.

(51) Int. Cl. H04B 7/04; H04W 76/04; H04B 7/06; H04W 16/28; H04W 24/08

(52) U.S. Cl. CPC H04B 7/0478; H04W 16/28; H04W 24/08; H04B 7/0626; H04W 76/046

(57) ABSTRACT

Embodiments of this disclosure provide a beam-based information transmission method and apparatus and a communications system. The information transmission method includes: a base station receives a measurement result obtained by measuring one or more beams and transmitted by user equipment; selects one or more transmission beams for the user equipment based on the measurement result; transmits information on the selected transmission beams to the user equipment; and performs diversity transmission of information by using the selected transmission beams. With the embodiments of this disclosure, a problem of coverage of the system may further be solved, and a good tradeoff between a diversity gain and a beamforming gain may be obtained. Furthermore, inter-cell interference may be efficiently suppressed, and an average throughput of the cell may be improved.

### CROSS REFERENCE TO RELATED APPLICATIONS

This application is a continuation application of International Application PCT/CN2014/083987 filed on Aug. 8, 2014, the entire contents of which are incorporated herein by reference.

### TECHNICAL FIELD

The present disclosure relates to the field of communications, and in particular to a beam-based information transmission method and apparatus and a communications system in a three-dimensional (3D) multiple input multiple output (MIMO) system.

### BACKGROUND

As the development of antenna technologies, a large amount of antennas may be arranged in a transmitter end. Three-dimensional beamforming technology of multiple antennas may improve antenna gains, reduce beam widths, efficiently suppress white noises and inter-cell random interference and improve efficiency and reliability of system transmission, which is a hot candidate technology for future mobile communications systems.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

In a relatively ideal situation, beams may change along with changes of user equipment, and provide relatively good services for the user equipment. However, it was found by the inventors that as movement of the user equipment, gains of directed beams will become less, even exceeding a coverage range of the beams, thereby affecting robustness of performance of the user equipment.

FIG. 1 is a schematic diagram of a 3D beamforming system. As shown in FIG. 1, when the user equipment moves, it may possibly go beyond a coverage range of the beam.

On the other hand, as the increase of the number of antennas, design of beams becomes more flexible. However, an existing transmit diversity scheme cannot further solve a coverage problem of the system, and a good tradeoff between a diversity gain and a beamforming gain cannot be obtained.

Embodiments of the present disclosure provide a beam-based information transmission method and apparatus and a communications system, in which a base station selects one or more beams based on measurement information fed back by user equipment and performs diversity transmission, or performs diversity transmission based on one or more beams formed by two-dimensional codebook rotation, thereby further solving the problem of coverage of the system, and obtaining a good tradeoff between a diversity gain and a beamforming gain.

According to a first aspect of the embodiments of the present disclosure, there is provided a beam-based information transmission method, including:

receiving, by a base station, a measurement result obtained by measuring one or more beams and transmitted by user equipment;

selecting one or more transmission beams for the user equipment based on the measurement result;

transmitting information on the selected transmission beams to the user equipment; and

performing, by the base station, diversity transmission of information by using the selected transmission beams.

According to a second aspect of the embodiments of the present disclosure, there is provided a beam-based information transmission apparatus, including:

a result receiving unit configured to receive a measurement result obtained by measuring one or more beams and transmitted by user equipment;

a beam selecting unit configured to select one or more transmission beams for the user equipment based on the measurement result;

an information transmitting unit configured to transmit information on the selected transmission beams to the user equipment; and

a diversity transmitting unit configured to perform diversity transmission of information by using the selected transmission beams.

According to a third aspect of the embodiments of the present disclosure, there is provided a beam-based information transmission method, including:

determining a codeword in a horizontal direction based on a horizontal codebook in a two-dimensional codebook, and determining a codeword in a vertical direction based on a vertical codebook in the two-dimensional codebook;

combining the codeword in a horizontal direction and the codeword in a vertical direction to form weighting coefficients of beams; and

performing diversity transmission of information by using one or more transmission beams generated from the weighting coefficients.

According to a fourth aspect of the embodiments of the present disclosure, there is provided a beam-based information transmission apparatus, including:

a codeword determining unit configured to determine a codeword in a horizontal direction based on a horizontal codebook in a two-dimensional codebook, and determine a codeword in a vertical direction based on a vertical codebook in the two-dimensional codebook;

a coefficient forming unit configured to combine the codeword in a horizontal direction and the codeword in a vertical direction to form weighting coefficients of beams; and

a diversity transmitting unit configured to perform diversity transmission of information by using one or more transmission beams generated from the weighting coefficients.

According to a fifth aspect of the embodiments of the present disclosure, there is provided a communications system, including:

a base station configured with the beam-based information transmission apparatus as described above; and

user equipment configured to receive a signal transmitted by the base station based on a beam.

According to another aspect of the embodiments of the present disclosure, there is provided a computer readable program code, which, when executed in a base station, will cause a computer unit to carry out the beam-based information transmission method as described above in the base station.

According to a further aspect of the embodiments of the present disclosure, there is provided a computer readable medium, including a computer readable program code, which will cause a computer unit to carry out the beam-based information transmission method as described above in a base station.

An advantage of the embodiments of the present disclosure exists in that the base station selects beams based on measurement information fed back by user equipment and performs diversity transmission, or performs diversity transmission based on beams formed by two-dimensional codebook rotation, thereby further solving the problem of coverage of the system, and obtaining a good tradeoff between a diversity gain and a beamforming gain.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of a 3D beamforming system;

FIG. 2 is a flowchart of the beam-based information transmission method of Embodiment 1 of this disclosure;

FIG. 3 is another flowchart of the beam-based information transmission method of Embodiment 1 of this disclosure;

FIG. 4 is a flowchart of performing diversity transmission by using wide beams and narrow beams of Embodiment 1 of this disclosure;

FIG. 5 is a flowchart of the beam-based information transmission method of Embodiment 2 of this disclosure;

FIG. 6 is a schematic diagram of using a downtilt angle of a specific coverage area of Embodiment 2 of this disclosure;

FIG. 7 is a schematic diagram of beams based on codebook rotation of Embodiment 2 of this disclosure;

FIG. 8 is a schematic diagram of a structure of the beam-based information transmission apparatus of Embodiment 3 of this disclosure;

FIG. 9 is a schematic diagram of a structure of the base station of Embodiment 3 of this disclosure;

FIG. 10 is a schematic diagram of a structure of the beam-based information transmission apparatus of Embodiment 4 of this disclosure; and

FIG. 11 is a schematic diagram of a structure of the communications system of Embodiment 5 of this disclosure.

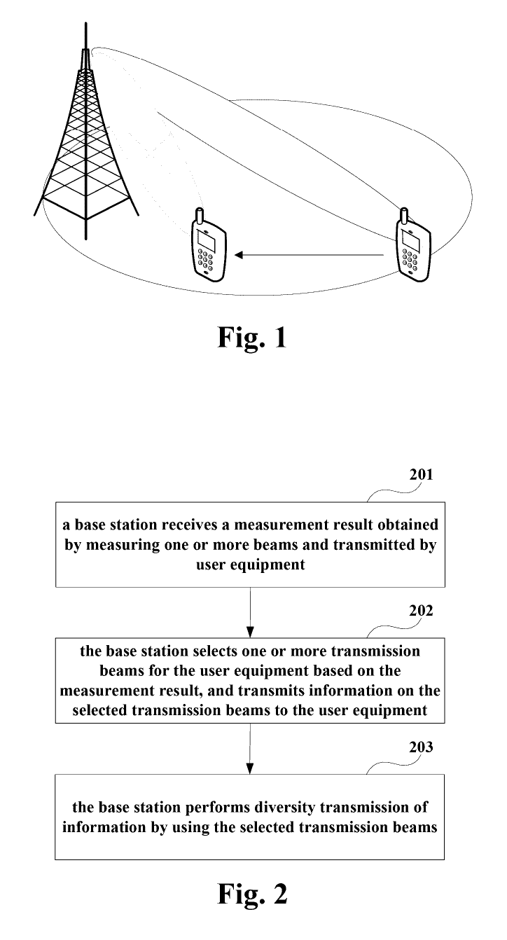

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of the present disclosure shall be described below with reference to the accompanying drawings.

### Embodiment 1

An embodiment of this disclosure provides a beam-based information transmission method, applicable to a base station side of a 3D MIMO system. This embodiment may be applicable to a scenario where user equipment moves at a low speed.

FIG. 2 is a flowchart of the beam-based information transmission method of the embodiment of this disclosure. As shown in FIG. 2, the method includes:

step 201: a base station receives a measurement result obtained by measuring one or more beams and transmitted by user equipment;

step 202: the base station selects one or more transmission beams for the user equipment based on the measurement result, and transmits information on the selected transmission beams to the user equipment; and

step 203: the base station performs diversity transmission of information by using the selected transmission beams.

In this embodiment, the base station may transmit one or more beams. Taking one piece of user equipment as an example, the user equipment may measure the one or more beams according to a configured or predefined reference signal, and report a measurement result to the base station. The measurement result may include reference signal received power (RSRP), or reference signal received quality (RSRQ), etc.; however, this disclosure is not limited thereto.

In this embodiment, the base station may select one or more transmission beams for the user equipment according to the measurement result, such as selecting some beams of relatively good measurement results (for example, channel quality is relatively good) from multiple beams. And the base station transmits the information on the selected transmission beams to the user equipment via signaling. The information on the transmission beams may include: the number of the selected transmission beams and/or identification of the selected transmission beams. However, this disclosure is not limited thereto, and the user equipment may demodulate the beams according to the information.

In this embodiment, the base station performs the diversity transmission of information by using the selected transmission beams. Hence, based on the measurement information fed back by the user equipment, the base station selects the transmission beams and performs the diversity transmission, thereby further solving a coverage problem of the system, and obtaining a good tradeoff between a diversity gain and a beamforming gain.

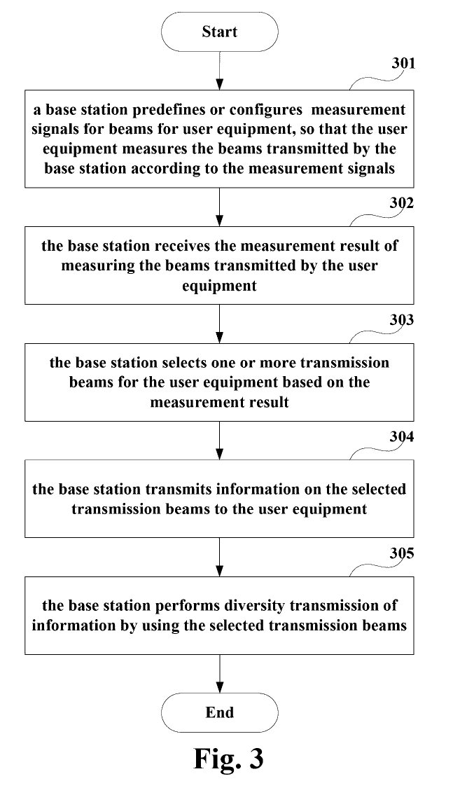

FIG. 3 is another flowchart of the beam-based information transmission method of the embodiment of this disclosure. As shown in FIG. 3, the method includes:

step 301: a base station predefines or configures measurement signals for beams for user equipment, so that the user equipment measures the beams transmitted by the base station according to the measurement signals;

in this embodiment, the base station may configure the user equipment with a measurement reference signal for the beams, or predefine measurement signals for some beams; and each piece of user equipment measures the beams of the base station according to the configured or predefined reference signals, and report the measurement result to the base station;

step 302: the base station receives the measurement result of measuring the beams transmitted by the user equipment;

step 303: the base station selects one or more transmission beams for the user equipment based on the measurement result;

the base station may select suitable transmission beams for each piece of user equipment according to scheduling, based on measurement results reported by multiple pieces of user equipment;

step 304: the base station transmits information on the selected transmission beams to the user equipment;

the base station may inform the user equipment of the number of the selected transmission beams and/or the identification of the selected transmission beams via high layer signaling, such as transmitting the number of the selected transmission beams and the identification of the selected transmission beams to the user equipment via a piece of high layer signaling, or transmitting them to the user equipment sequentially via different pieces of signaling; step 305: the base station performs diversity transmission of information by using the selected transmission beams.

A scheme of diversity transmission shall be described below.

In this embodiment, weighting coefficients F of the transmission beams are cyclically traversed in a frequency domain.

In an implementation, the base station performs the diversity transmission by using a beam a and a beam b at a frequency i and a frequency j; a transmission signal to which the beam a corresponds at the frequency i is HᵢFₐSᵢ, a transmission signal to which the beam b corresponds at the frequency i is HᵢF_{b}Sⱼ; and a transmission signal to which the beam a corresponds at the frequency j is −HⱼFₐSⱼ*, a transmission signal to which the beam b corresponds at the frequency j is HⱼF_{b}Sᵢ*;

where, H denotes a channel, F is a weighting coefficient of the transmission beam, and S is a transmission symbol; i, j, a and b may be, for example, positive integers greater than 0; i and j may be consecutive indices, and a and b may be consecutive indices; however, this disclosure in not limited thereto, and they may also be nonconsecutive indices.

In particular, the base station may perform the diversity transmission by using a scheme as below:

| | Beam 1 | Beam 2 | Beam 3 | | Beam 4 | . . . |
|---|---|---|---|---|---|---|
| Frequency 1 | H₁F₁S₁ | H₁F₂S₂ | | | | |
| | | | | 0 | | |
| Frequency 2 | −H₂F₁S₂* | H₂F₂S₁* | | | | |
| Frequency 3 | | H₃F₂S₃ | H₃F₃S₄ | | | |
| | 0 | | | | 0 | |
| Frequency 4 | | −H₄F₂S₄* | H₄F₃S₃* | | | |
| Frequency 5 | | | H₅F₃S₅ | | H₅F₄S₆ | |
| | 0 | 0 | | | | |
| Frequency 6 | | | −H₆F₃S₆* | | H₆F₄S₅* | |
| . . . | | | | | | |

As described above, the base station may perform the diversity transmission by using two beams; for example, at frequencies 1 and 2, beams of F1 and F2 are used; and at frequencies 3 and 4, beams of F2 and F3 are used, . . . . Furthermore, for example, at frequencies 9 and 10 (not shown), the base station uses the beams of F1 and F2 again, thereby achieving cyclical traversing of the weighting coefficients F.

In another implementation, the base station performs the diversity transmission by using the beam a at the frequency i;

a transmission signal to which the beam a corresponds at the frequency i is HᵢFₐSᵢ; where, H denotes a channel, F is a weighting coefficient of the transmission beam, and S is a transmission symbol; i and a may be, for example, positive integers greater than 0.

In particular, the base station may perform the diversity transmission by using a scheme as below:

| | Beam 1 | | Beam 2 | | Beam 3 | | Beam 4 | . . . |
|---|---|---|---|---|---|---|---|---|
| Frequency 1 | H₁F₁S₁ | | 0 | | | | | |
| | | | | | | 0 | | |
| Frequency 2 | 0 | | H₂F₂S₂ | | | | | |
| Frequency 3 | | | | | H₃F₂S₃ | | | |
| | | 0 | | | | | | |
| Frequency 4 | | | | | | | H₄F₄S₄ | |
| | | | | 0 | | | | |
| Frequency 5 | H₅F₁S₅ | | | | | | | |
| | | | | | | | 0 | |
| Frequency 6 | | | H₆F₂S₆ | | | | | |
| . . . | | | | | | | | |

As described above, the base station may perform the diversity transmission by using one beam; for example, at frequency 1, the beam of F1 is used; and at frequency 2, the beam of F2 is used, . . . . Furthermore, as described above, at frequency 5, the base station uses the beam of F1 again, . . . thereby achieving cyclical traversing of the weighting coefficients F.

It should be noted that the above diversity transmission schemes are some implementations of this disclosure only; however, this disclosure is not limited thereto, and other diversity transmission schemes may also be used, for example.

In this embodiment, it is also applicable to joint diversity transmission of a spatial domain and a polarization domain, that is, in a case where cross polarization antennas are used, identical signals may be transmitted in two polarization directions at a frequency, thereby further improving performance of diversity transmission.

In this embodiment, before performing diversity transmission of information by using the selected transmission beams by the base station in step 203 or 305, the method may further include: optimizing the transmission beams at a beam interval and/or beam overlapping.

In particular, a use frequency of the transmission beams may be changed according to a probability that the transmission beams are used. For example, if a probability that a transmission beam is used is relatively large, a relatively high use frequency may be given to the beam in a process of beam circulation.

Or one or more transmission beams may be repeatedly used within a period of time. For example, a beam overlapping method may be employed to increase a use probability and improve robustness of transmission. As described in the above diversity scheme in which two beams are simultaneously used in transmission, beam 2 of a weighting coefficient F2 is used both in a first time transmission and a second time of transmission. If opportunities that all the beams are used are equal, circulation may be performed directly without needing to be repeated, thereby further improving performance of diversity transmission.

In this embodiment, the transmission beams may include wide beams and narrow beams, and the base station may perform the diversity transmission of information based on the wide beams and narrow beams having different beam widths. Furthermore, the base station may transmit information on the wide beams and/or the narrow beams to the user equipment, so that the user equipment may accurately perform demodulation. For example, the base station may transmit information on which are wide beams to the user equipment.

Circulation frequencies of the wide beams and the narrow beams may be different. For example, two wide beams, X1 and X2, and fourth narrow beams, Y1, Y2, Y3 and Y4, may be used. And X1 and Y1 may be used in a time of transmission, X1 and Y2 may be used in a next time of transmission, X1 and Y3 may be used in a further next time of transmission, and X1 and Y4 may be used in a yet next time of transmission; then, X2 and Y1 are used, . . . .

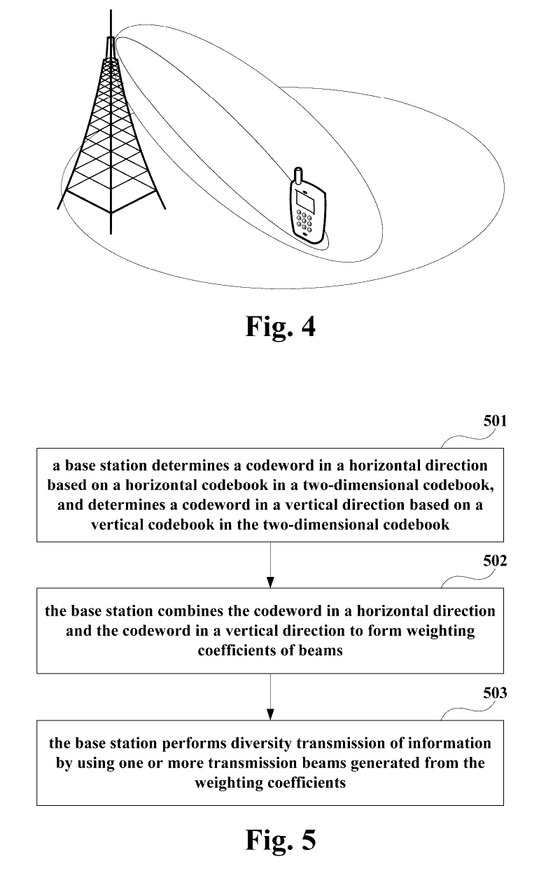

FIG. 4 is a flowchart of performing diversity transmission by using wide beams and narrow beams of the embodiment of this disclosure. As shown in FIG. 4, the user equipment may be in coverage ranges of the wide beams and the narrow beams, hence, the base station may perform the diversity transmission of information based on the beams having different beam widths.

In this embodiment, the base station may configure the measurement signal for the user equipment when the user equipment and the base station are in a radio resource control (RRC) connected state. For example, a channel state information reference signal (CSI-RS) based on a beam, a common reference signal (CRS) based on a beam, or other reference signals based on user equipment, may be used. And the base station may predefine the measurement signal when the user equipment and the base station are not in an RRC connected state. The predefined measurement signal may occupy a position of a CSI-RS resource and/or a position of a CRS resource.

For example, the base station may predefine some measurement resources for beam measurement, and the user equipment measures these resources and reports a measurement result. In order to reduce an effect on low-version user equipment, the predefined resources may occupy positions of CSI-RS resources; a granularity of the resources may include a grade of a subframe, or a grade of physical resource block (PRB).

In this embodiment, the measurement signal may be a CSI-RS based on a beam and/or a CRS based on a beam, that is, the base station may use the weighting coefficient F of the beam to precode the CSI-RS or the CRS.

The user equipment may feed back channel quality indicator (CQI) information to the base station, the CQI information being obtained by the user equipment according to the CSI-RS based on a beam (and/or the CRS based on a beam) and a transmit diversity scheme.

That is, a conventional diversity scheme is transmitted based on a common reference signal (CRS), namely, ports seen by all pieces of user equipment are consistent. However, positions of the pieces of user equipment are actually different, and directions of beams that are efficiently transmitted are inconsistent. This requires that ports seen by the user equipment are mutually independent.

Hence, new feedback of different reference signals based on user equipment is defined in the embodiments of this disclosure, such as a transmit diversity scheme based on feedback of a CSI-RS. And when the user equipment calculates CQI feedback, it is obtained according to the CSI-RS based on a beam (and/or the CRS based on a beam) and a transmit diversity scheme.

Table 1 shows a transmission scheme of physical downlink shared channel (PDSCH) assumed for CSI reference resources. Contents of “PDSCH transmission scheme assumed for CSI reference resource” in an existing standard may be referred to for transmission modes 1-10 in Table 1.

As shown in Table 1, a transmission mode 11 may defined, which corresponds to a CSI-RS based on a beam (and/or a CRS based on a beam).

TABLE 1

| Transmission mode | Transmission scheme of PDSCH |
|---|---|
| 11 | Transmit diversity or any other transmission |
| (Enhanced TM3) | scheme on CSI-RS/CRS based on beam, for |
| | example port 15-21 |

It can be seen from the above embodiment that the base station selects one or more beams based on measurement information fed back by user equipment and performs diversity transmission, thereby further solving the problem of coverage of the system, and obtaining a good tradeoff between a diversity gain and a beamforming gain. Furthermore, inter-cell interference may be efficiently suppressed, and an average throughput of the cell may be improved.

### Embodiment 2

An embodiment of this disclosure provides a beam-based information transmission method, applicable to a base station side of a 3D MIMO system. This embodiment may be applicable to a scenario where user equipment moves at a high speed.

FIG. 5 is a flowchart of the beam-based information transmission method of the embodiment of this disclosure. As shown in FIG. 5, the method includes:

step 501: a base station determines a codeword in a horizontal direction based on a horizontal codebook in a two-dimensional codebook, and determines a codeword in a vertical direction based on a vertical codebook in the two-dimensional codebook;

step 502: the base station combines the codeword in a horizontal direction and the codeword in a vertical direction to form weighting coefficients of beams; and

step 503: the base station performs diversity transmission of information by using one or more transmission beams generated from the weighting coefficients.

In a high-speed movement scenario, channel state information invalidates quickly, and a diversity scheme based on feedback assistance is less ideal. In this embodiment, a diversity transmission method based on two-dimensional codebook rotation is used, and performance of diversity transmission may be improved. The relevant art may be referred to for the two-dimensional codebook including a horizontal codebook and a vertical codebook.

In this embodiment, in the horizontal direction, one or more codewords (such as four codewords) of the horizontal codebook may be followed to form the codewords in the horizontal direction; and in the vertical direction, a downtilt angle based on a specific coverage area may be used to form the codewords in the vertical direction (such as two codewords). And then the codewords in the horizontal direction and the codewords in the vertical direction are combined, so as to generate weighting coefficient F of beams, thereby forming beams.

FIG. 5 shows a case where weighting coefficients of beams are generated based on a two-dimensional codebook. In this embodiment, the codebook in the horizontal direction may be cyclically traversed, so as to determine the codewords in the horizontal. For example, a first and second codewords are selected from the horizontal codebook at a time and are taken as the codewords in the horizontal, and a third and fourth codewords are selected from the horizontal codebook at a next time and are taken as the codewords in the horizontal, and so on. Likewise, the codebook in the vertical direction may be cyclically traversed. In this way, multiple weighting coefficients based on two-dimensional codebook rotation are generated, and are cyclically used in the frequency domain.

For example, for two ports, the horizontal codebook may be as described below:

| | Number of layers | |
|---|---|---|
| Codebook index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

For another example, for two ports, the horizontal codebook may be as described below:

| | Number of layers | |
|---|---|---|
| Codebook index | 1 | 2 |
| 0 | $\frac{1}{\sqrt{2}} [ \begin{matrix}1 \\ 1\end{matrix} ]$ | $\frac{1}{2} [ \begin{matrix}1 & 1 \\ 1 & - 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ j & - j\end{matrix} ]$ |
| 2 | $\frac{1}{\sqrt{2}} [ \begin{matrix}1 \\ j\end{matrix} ]$ | — |
| 3 | $\frac{1}{\sqrt{2}} [ \begin{matrix}1 \\ - j\end{matrix} ]$ | — |

For fourth ports, the horizontal codebook may be as described below:

| Codebook | | Number of layers | | | |
|---|---|---|---|---|---|
| index | uₙ | 1 | 2 | 3 | 4 |
| 12 | u₁₂ = [1 −1 −1 1]^{T} | W₁₂^{{1}} | W₁₂^{{12}}/\sqrt{2} | W₁₂^{{123}}/\sqrt{3} | W₁₂^{{1234}}/2 |
| 13 | u₁₃ = [1 −1 1 −1]^{T} | W₁₃^{{1}} | W₁₃^{{13}}/\sqrt{2} | W₁₃^{{123}}/\sqrt{3} | W₁₃^{{1324}}/2 |
| 14 | u₁₄ = [1 1 −1 −1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{123}}/\sqrt{3} | W₁₅^{{1234}}/2 |

where, Wₙ=I−2uₙuₙ^{H}/uₙ^{H}uₙ.

For the sake of convenience, particular examples of the vertical codebook are not shown, and the relevant art may be referred to.

Taking two ports as an example, a codeword

$$\frac{1}{\sqrt{2}} [ \begin{matrix}1 \\ 1\end{matrix} ]$$

may be selected from the horizontal codebook and a codeword Wᵥ₁ may be selected from the vertical codebook at a time of transmission, and the two codewords are combined to form a weighting coefficient F₁ of the beams, and a codeword

$$\frac{1}{\sqrt{2}} [ \begin{matrix}1 \\ - 1\end{matrix} ]$$

may be selected from the horizontal codebook and a codeword Wᵥ₂ may be selected from the vertical codebook at a next time of transmission, and the two codewords are combined to form a weighting coefficient F₂ of the beams, and so on, thereby generating multiple weighting coefficients based on two-dimensional codebook rotation. It should be noted that the above description is given taking that two codewords are combined as an example, and in particular implementation, multiple codewords in the horizontal direction and multiple codewords in the vertical direction may be determined and combined.

In this embodiment, the base station may use the downtilt angle based on a specific coverage area to determine the codewords in the vertical direction based on the vertical codebook. For example, for a vertical domain,

W=[1exp(−2*pi*j*d/lamda*cos(theta_tilt))];

where, theta_til is an area needing to be covered by the vertical domain, d is an antenna element interval, and lamda is a wavelength of a signal. It should be noted that how to use the downtilt angle based on a specific coverage area is illustrated above only; however, this disclosure is not limited thereto, and particular codewords in the vertical direction may be determined according to an actual situation.

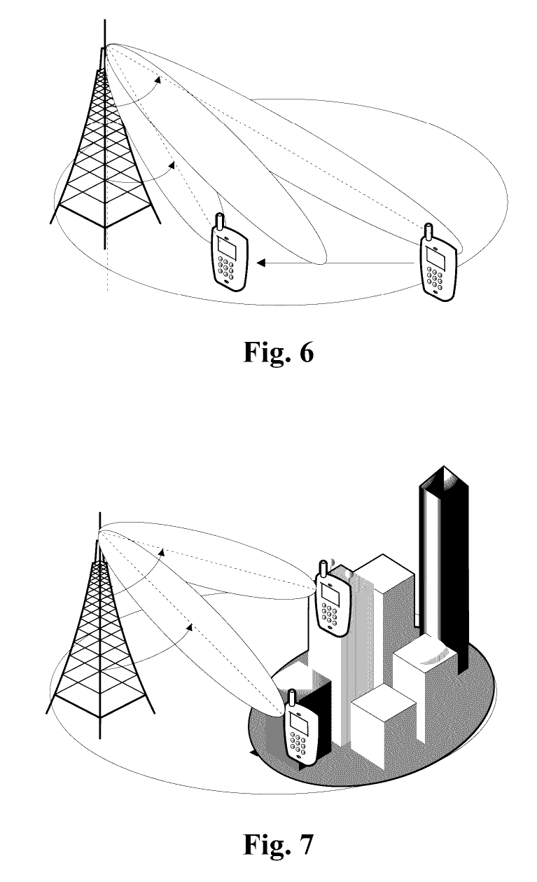

FIG. 6 is a schematic diagram of using a downtilt angle of a specific coverage area of the embodiment of this disclosure, the codewords in the vertical direction being determined by the downtilt angle. And FIG. 7 is a schematic diagram of beams based on codebook rotation of the embodiment of this disclosure. Hence, the beams may be generated based on the two-dimensional codebook rotation, and the diversity transmission may be performed by using the generated beams.

In this embodiment, a Kroneck method, for example, may be used for combining; however, this embodiment is not limited thereto, and a particular method may be determined according to an actual situation. And furthermore, Embodiment 1 may be referred to for a diversity transmission scheme, which shall not be described herein any further. As to feedback of the user equipment, it may be performed according to the CSI-RS based on a beam (and/or the CRS based on a beam), as described in Embodiment 1.

In this embodiment, the beams may perform spatial circulation to change the weighting coefficients F of the wide beams, such as by traversing the codebook, or traversing a DFT matrix space. And the base station may further predefine the measurement signal for the beams, the predefine measurement signal may occupy a position of a CSI-RS resource and/or a position of a CRS resource.

In this embodiment, the base station may receive information fed back by user equipment based on the measurement signal; the measurement signal may be a CSI-RS based on a beam and/or a CRS based on a beam. For example, the information is CQI fed back to the base station by the user equipment, the CQI information being obtained according to the CSI-RS based on a beam (and/or the CRS based on a beam and a transmit diversity scheme.

It can be seen from the above embodiment that the base station performs diversity transmission based on beams formed by two-dimensional codebook rotation, thereby further solving the problem of coverage of the system, and obtaining a good tradeoff between a diversity gain and a beamforming gain. Furthermore, inter-cell interference may be efficiently suppressed, and an average throughput of the cell may be improved.

### Embodiment 3

An embodiment of this disclosure provides a beam-based information transmission apparatus, configured in a base station of a 3D MIMO system. This embodiment corresponds to Embodiment 1, with identical contents being not going to be described herein any further.

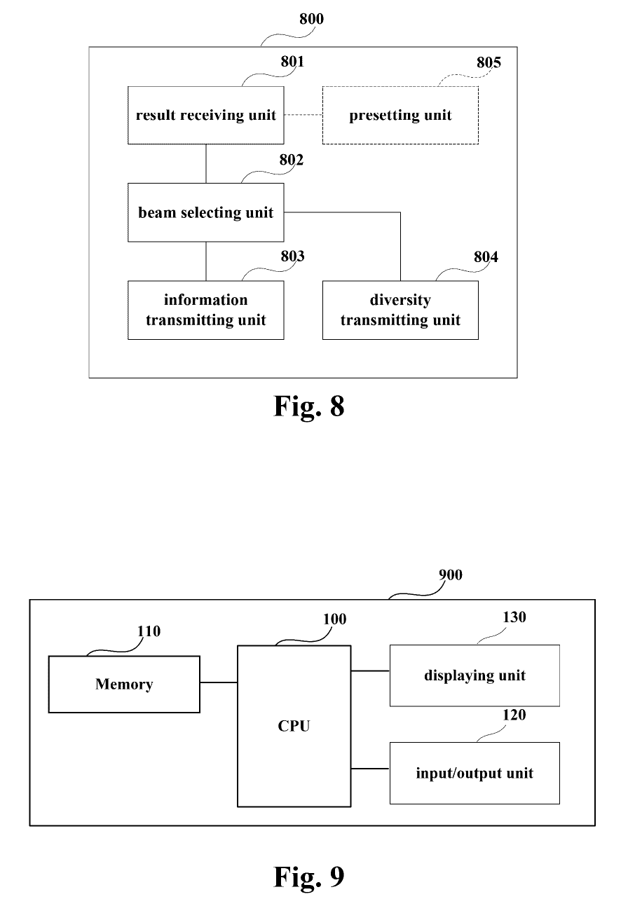

FIG. 8 is a schematic diagram of a structure of the beam-based information transmission apparatus of the embodiment of this disclosure. As shown in FIG. 8, the beam-based information transmission apparatus 800 includes:

a result receiving unit 801 configured to receive a measurement result obtained by measuring one or more beams and transmitted by user equipment;

a beam selecting unit 802 configured to select one or more transmission beams for the user equipment based on the measurement result;

an information transmitting unit 803 configured to transmit information on the selected transmission beams to the user equipment; and

a diversity transmitting unit 804 configured to perform diversity transmission of information by using the selected transmission beams.

As shown in FIG. 8, the beam-based information transmission apparatus 800 may further include:

a presetting unit 805 configured to predefine or configure measurement signals for the beams for the user equipment, so that the user equipment measures the beams transmitted by the base station according to the measurement signals.

The information on the transmission beams may include: the number of the selected transmission beams and/or identification of the selected transmission beams; however, this disclosure in not limited thereto.—

In this embodiment, weighting coefficients of the transmission beams may be cyclically traversed in a frequency domain.

In an implementation, the diversity transmitting unit 804 is configured to perform the diversity transmission by using a beam a and a beam b at a frequency i and a frequency j;

a transmission signal to which the beam a corresponds at the frequency i is HᵢFₐSᵢ, a transmission signal to which the beam b corresponds at the frequency i is HᵢF_{b}Sⱼ; and a transmission signal to which the beam a corresponds at the frequency j is −HⱼFₐSⱼ*, a transmission signal to which the beam b corresponds at the frequency j is HⱼF_{b}Sᵢ*; where, H denotes a channel, F is a weighting coefficient of the transmission beam, and S is a transmission symbol.

In another implementation, the diversity transmitting unit 804 is configured to perform the diversity transmission by using a beam a at a frequency i;

a transmission signal to which the beam a corresponds at the frequency i is HᵢFₐSᵢ; where, H denotes a channel, F is a weighting coefficient of the transmission beam, and S is a transmission symbol.

In this embodiment, the diversity transmitting unit 804 may further be configured to optimize the transmission beams at a beam interval and/or beam overlapping before performing the diversity transmission of information by using the selected transmission beams. In particular, the diversity transmitting unit 804 may change a use frequency of the transmission beams according to a probability that the transmission beams are used; or the diversity transmitting unit 804 may repeatedly use one or more transmission beams within a period of time.

In an implementation, the transmission beams may include wide beams and narrow beams having different beam widths, and the diversity transmitting unit 804 may perform the diversity transmission of information based on the wide beams and narrow beams. Furthermore, the information transmitting unit 803 may further be configured to transmit information on the wide beams and/or the narrow beams to the user equipment.

In this embodiment, the presetting unit 805 may be configured to configure the measurement signal for the user equipment when the user equipment and the base station are in an RRC connected state, and predefine the measurement signal when the user equipment and the base station are not in an RRC connected state. The predefined measurement signal may occupy a position of a CSI-RS resource.

In this embodiment, the measurement signal may be a CSI-RS based on a beam and/or a CRS based on a beam. The CQI information fed back by the user equipment to the base station is obtained according to the CSI-RS based on a beam (and/or the CRS based on a beam) and a transmit diversity scheme.

An embodiment of this disclosure further provides a base station, including the beam-based information transmission apparatus 800 described above.

FIG. 9 is a schematic diagram of a structure of the base station of the embodiment of this disclosure. As shown in FIG. 9, the base station 900 may include a central processing unit (CPU) 100 and a memory 110, the memory 110 being coupled to the central processing unit 100. The memory 110 may store various data, and furthermore, it may store a program for information processing, and execute the program under control of the central processing unit 100.

In an implementation, the functions of the beam-based information transmission apparatus 800 may be integrated into the central processing unit 100. The central processing unit 110 may be configured to carry out the information transmission method as described in Embodiment 1.

In another implementation, the beam-based information transmission apparatus 800 and the central processing unit 110 may be configured separately. For example, the beam-based information transmission apparatus 800 may be configured as a chip connected to the central processing unit 110, with its functions being realized under control of the central processing unit 110.

Furthermore, as shown in FIG. 9, the base station 900 may further include an input/output unit 120, and a displaying unit 130, etc. Functions of the above components are similar to those in the relevant art, and shall not be described herein any further. It should be noted that the base station 900 does not necessarily include all the parts shown in FIG. 9, and furthermore, the base station 900 may include parts not shown in FIG. 9. And the relevant art may be referred to for a particular constitution of the base station.

It can be seen from the above embodiment that the base station selects beams based on measurement information fed back by user equipment and performs diversity transmission, thereby further solving the problem of coverage of the system, and obtaining a good tradeoff between a diversity gain and a beamforming gain. Furthermore, inter-cell interference may be efficiently suppressed, and an average throughput of the cell may be improved.

### Embodiment 4

An embodiment of this disclosure provides a beam-based information transmission apparatus, configured in a base station of a 3D MIMO system. This embodiment corresponds to Embodiment 2, with identical contents being not going to be described herein any further.

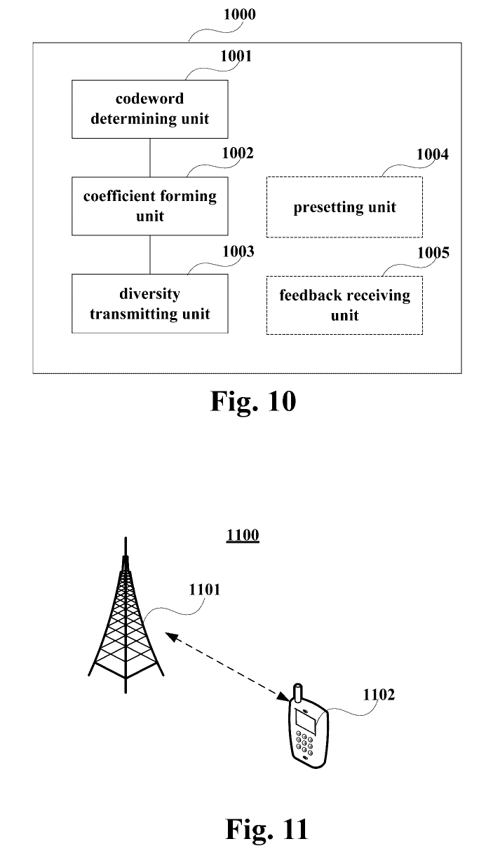

FIG. 10 is a schematic diagram of a structure of the beam-based information transmission apparatus of the embodiment of this disclosure. As shown in FIG. 10, the beam-based information transmission apparatus 1000 includes:

a codeword determining unit 1001 configured to determine a codeword in a horizontal direction based on a horizontal codebook in a two-dimensional codebook, and determine a codeword in a vertical direction based on a vertical codebook in the two-dimensional codebook;

a coefficient forming unit 1002 configured to combine the codeword in a horizontal direction and the codeword in a vertical direction to form weighting coefficients of beams; and

a diversity transmitting unit 1003 configured to perform diversity transmission of information by using one or more transmission beams generated from the weighting coefficients.

In this embodiment, the codeword determining unit 1001 may be configured to cyclically traverse the horizontal codebook to determine the codeword in a horizontal direction, and traverse the vertical codebook to determine the codeword in a vertical direction, so that the coefficient forming unit 1002 is configured to form multiple weighting coefficients based on rotation of the two-dimensional codebook.

In this embodiment, the codeword determining unit 1001 may be configured to determine the codeword in a vertical direction based on the vertical codebook by using a downtilt angle based on a specific coverage area.

As shown in FIG. 10, the beam-based information transmission apparatus 1000 may further include:

a presetting unit 1004 configured to predefine a measurement signal for the beam, the predefined measurement signal occupying a position of a CSI-RS resource and/or a position of a CRS resource.

As shown in FIG. 10, the beam-based information transmission apparatus 1000 may further include:

a feedback receiving unit 1005 configured to receive information fed back by user equipment based on the measurement signal; the measurement signal is a CSI-RS based on a beam and/or a CRS based on a beam.

For example, the information is CQI fed back to the base station by the user equipment, the CQI information being obtained according to the CSI-RS based on a beam and/or CRS based on a beam and a transmit diversity scheme.

An embodiment of this disclosure further provides a base station, including the beam-based information transmission apparatus 1000 described above, and FIG. 9 may be referred to for a structure of the base station.

It can be seen from the above embodiment that the base station performs diversity transmission based on beams formed by two-dimensional codebook rotation, thereby further solving the problem of coverage of the system, and obtaining a good tradeoff between a diversity gain and a beamforming gain. Furthermore, inter-cell interference may be efficiently suppressed, and an average throughput of the cell may be improved.

### Embodiment 5

An embodiment of this disclosure provides a communications system. FIG. 11 is a schematic diagram of a structure of the communications system of the embodiment of this disclosure. As shown in FIG. 11, the communications system 1100 includes:

a base station 1101 configured with the beam-based information transmission apparatus 800 as described in Embodiment 3, or the beam-based information transmission apparatus 1000 as described in Embodiment 4; and

user equipment 1102 configured to receive a signal transmitted by the base station 1101 based on a beam.

An embodiment of the present disclosure provides a computer readable program code, which, when executed in a base station, will cause a computer unit to carry out the information transmission method as described in Embodiment 1 or 2 in the base station.

An embodiment of the present disclosure provides a computer readable medium, including a computer readable program code, which will cause a computer unit to carry out the information transmission method as described in Embodiment 1 or 2 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments.

However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A beam-based information transmission apparatus, configured in a base station of a 3D MIMO system, the beam-based information transmission apparatus comprising:
a result receiving unit configured to receive a measurement result obtained by measuring one or more beams and transmitted by user equipment;
a beam selecting unit configured to select one or more transmission beams for the user equipment based on the measurement result;
an information transmitting unit configured to transmit information on the selected transmission beams to the user equipment; and
a diversity transmitting unit configured to perform diversity transmission of information by using the selected transmission beams.

2. The beam-based information transmission apparatus according to claim 1, wherein the beam-based information transmission apparatus further comprises:
a presetting unit configured to predefine or configure measurement signals for the beams for the user equipment, so that the user equipment measures the beams transmitted by the base station according to the measurement signals.

3. The beam-based information transmission apparatus according to claim 1, wherein the information on the transmission beams comprises: the number of the selected transmission beams and/or identification of the selected transmission beams.

4. The beam-based information transmission apparatus according to claim 3, wherein the information transmitting unit is configured to transmit the information on the transmission beams to the user equipment via high-layer signaling.

5. The beam-based information transmission apparatus according to claim 1, wherein weighting coefficients of the transmission beams are cyclically traversed in a frequency domain.

6. The beam-based information transmission apparatus according to claim 5, wherein the diversity transmitting unit is configured to perform the diversity transmission by using a beam a and a beam b at a frequency i and a frequency j;
wherein, a transmission signal to which the beam a corresponds at the frequency i is HᵢFₐSᵢ, a transmission signal to which the beam b corresponds at the frequency i is HᵢF_{b}Sⱼ; and a transmission signal to which the beam a corresponds at the frequency j is −HⱼFₐSⱼ*, a transmission signal to which the beam b corresponds at the frequency j is HⱼF_{b}Sᵢ*; where, H denotes a channel, F is a weighting coefficient of the transmission beam, and S is a transmission symbol.

7. The beam-based information transmission apparatus according to claim 5, wherein the diversity transmitting unit is configured to perform the diversity transmission by using the beam a at the frequency i;
wherein, a transmission signal to which the beam a corresponds at the frequency i is HᵢFₐSᵢ; where, H denotes a channel, F is a weighting coefficient of the transmission beam, and S is a transmission symbol.

8. The beam-based information transmission apparatus according to claim 1, wherein the diversity transmitting unit is further configured to: optimize the transmission beams at a beam interval and/or beam overlapping before performing the diversity transmission of information by using the selected transmission beams;
and wherein the diversity transmitting unit is configured to change a use frequency of the transmission beams according to a probability that the transmission beams are used, or the diversity transmitting unit is configured to repeatedly use one or more transmission beams within a period of time.

9. The beam-based information transmission apparatus according to claim 1, wherein the transmission beams comprise wide beams and narrow beams having different beam widths;
the diversity transmitting unit is configured to perform the diversity transmission of information based on the wide beams and the narrow beams;
and the information transmitting unit is further configured to transmit information on the wide beams and/or the narrow beams to the user equipment.

10. The beam-based information transmission apparatus according to claim 2, wherein the presetting unit is configured to configure the measurement signal for the user equipment when the user equipment and the base station are in a radio resource control (RRC) connected state, and predefine the measurement signal when the user equipment and the base station are not in an RRC connected state.

11. The beam-based information transmission apparatus according to claim 1, wherein the predefined measurement signal occupies a position of a channel state information reference signal (CSI-RS) resource and/or a position of a common reference signal (CRS) resource.

12. The beam-based information transmission apparatus according to claim 1, wherein the measurement signal is a CSI-RS based on a beam and/or a CRS based on a beam.

13. The beam-based information transmission apparatus according to claim 12, wherein channel quality indicator (CQI) fed back to the base station by the user equipment is obtained according to the CSI-RS based on a beam and/or CRS based on a beam and a transmit diversity scheme.

14. A beam-based information transmission apparatus, configured in a base station of a 3D MIMO system, the beam-based information transmission apparatus comprising:
a codeword determining unit configured to determine a codeword in a horizontal direction based on a horizontal codebook in a two-dimensional codebook, and determine a codeword in a vertical direction based on a vertical codebook in the two-dimensional codebook;
a coefficient forming unit configured to combine the codeword in a horizontal direction and the codeword in a vertical direction to form weighting coefficients of beams; and
a diversity transmitting unit configured to perform diversity transmission of information by using one or more transmission beams generated from the weighting coefficients.

15. The beam-based information transmission apparatus according to claim 14, wherein the codeword determining unit is configured to cyclically traverse the horizontal codebook to determine the codeword in a horizontal direction, and traverse the vertical codebook to determine the codeword in a vertical direction, so that the coefficient forming unit is configured to generate multiple weighting coefficients based on rotation of the two-dimensional codebook.

16. The beam-based information transmission apparatus according to claim 14, wherein the codeword determining unit is configured to determine the codeword in a vertical direction based on the vertical codebook by using a downtilt angle based on a specific coverage area.

17. The beam-based information transmission apparatus according to claim 14, wherein the beam-based information transmission apparatus further comprises:
a presetting unit configured to predefine a measurement signal for the beam, the predefined measurement signal occupying a position of a CSI-RS resource and/or a position of a CRS resource.

18. The beam-based information transmission apparatus according to claim 14, wherein the beam-based information transmission apparatus further comprises:
a feedback receiving unit configured to receive information fed back by user equipment based on the measurement signal; wherein the measurement signal is a CSI-RS based on a beam and/or a CRS based on a beam.

19. The beam-based information transmission apparatus according to claim 18, wherein the information is CQI fed back to the base station by the user equipment, the CQI information being obtained according to the CSI-RS based on a beam and/or CRS based on a beam and a transmit diversity scheme.

20. A communications system, comprising:
a base station configured with the beam-based information transmission apparatus as claimed in claim 14 and
user equipment configured to receive a signal transmitted by the base station based on a beam.
